(19) United States
(12) Patent Application Publication
(10) Pub. No.: US 2024/0354898 A1
(43) Pub. Date: Oct. 24, 2024

(54) IMAGE PROCESSING METHOD AND IMAGE PROCESSING DEVICE

(71) Applicant: MEDIATEK INC., Hsin-chu (TW)

(72) Inventors: Sung-Hsien Hsieh, Hsinchu City (TW); Yen-Hsiang Tseng, Hsinchu City (TW); Wei-Te Chang, Hsinchu City (TW)

(73) Assignee: MEDIATEK INC., Hsin-chu (TW)

(21) Appl. No.: 18/402,757

(22) Filed: Jan. 3, 2024

Related U.S. Application Data
(60) Provisional application No. 63/460,322, filed on Apr. 19, 2023.

(51) Int. Cl. G06T 5/50; G06T 7/194; G06V 10/25; G06V 10/60

(52) U.S. Cl. CPC G06T 5/50; G06T 7/194; G06V 10/25; G06V 10/60; G06T 2207/20221

(57) ABSTRACT

An image processing method of increasing image quality is applied to an image processing device and includes setting a plurality of regions of interest within an input image, generating a weight map in accordance with the plurality of regions of interest identified from the input image, applying a plurality of gain values to the input image for respectively generating a plurality of duplicated images, and utilizing the weight map to synthesize the plurality of duplicated images for acquiring an output image.

### CROSS REFERENCE TO RELATED APPLICATIONS

This application claims the benefit of U.S. Provisional Application No. 63/460,322, filed on Apr. 19, 2023. The content of the application is incorporated herein by reference.

### BACKGROUND

Please refer to FIG. 4. FIG. 4 is a diagram of an image processing flow in the prior art. In the conventional image processing flow, an input image I_input is processed by multi-ROI based gain processing to generate an output image I_output for relighting an interested content inside the input image I_input. If the input image I_input is processed by the global gain, the whole input image I_input is amplified and cannot adjust brightness of one or some interested content inside the input image I_input independently. If the input image I_input is processed by the local gain, the interested content that is near to other content is obviously influenced by the said other content, so the interested content and the said other content are hard to differentiate from each other. Therefore, design of an image processing method of performing flexible exposure control for different regions of interest is an important issue in the related image analysis industry.

### SUMMARY

The present invention provides an image processing method and related image processing device used to increasing image quality for solving above drawbacks.

According to the claimed invention, an image processing method of increasing image quality includes setting a plurality of regions of interest within an input image, generating a weight map in accordance with the plurality of regions of interest identified from the input image, applying a plurality of gain values to the input image for respectively generating a plurality of duplicated images, and utilizing the weight map to synthesize the plurality of duplicated images for acquiring an output image.

According to the claimed invention, an image processing device of increasing image quality includes an image receiver and an operation module. The image receiver is adapted to receive an input image. The operation module is electrically connected with the image receiver. The operation module is adapted to identify and set a plurality of regions of interest within the input image, generate a weight map in accordance with the plurality of regions of interest from the input image, apply a plurality of gain values to the input image for respectively generating a plurality of duplicated images, and utilize the weight map to synthesize the plurality of duplicated images for acquiring an output image.

The image processing method and the image processing device of the present application can perform flexible exposure control based on multi-ROI, so as to flexibly control the brightness of the specific content inside the input image with less influence by other content. The image processing method can duplicate the input image to multiple ones, and apply the multiply gains favor to each ROI to each the duplicated images; the image processing method can further generate the weight map, which includes the weight smooth function and is parallel to other image processing, and synthesize the duplicated images via the weight map to acquire the output image that is natural and artifact-less for preferred image quality.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image processing device according to an embodiment of the present application.

FIG. 2 is a flow chart of an image processing method according to the embodiment of the present application.

FIG. 3 is a functional block diagram of conversion process of an input image according to the embodiment of the present application.

FIG. 4 is a diagram of an image processing flow in the prior art.

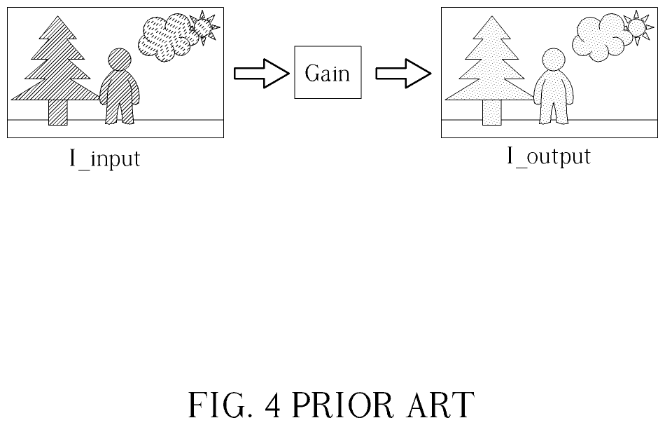

### DETAILED DESCRIPTION

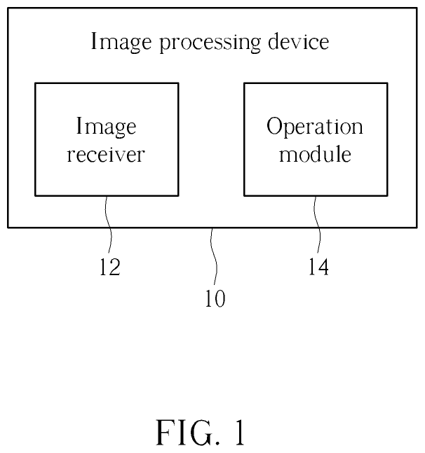

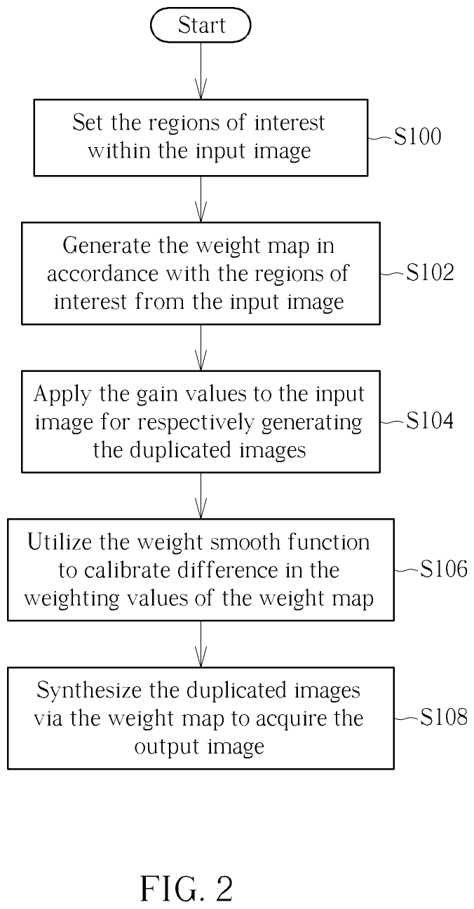

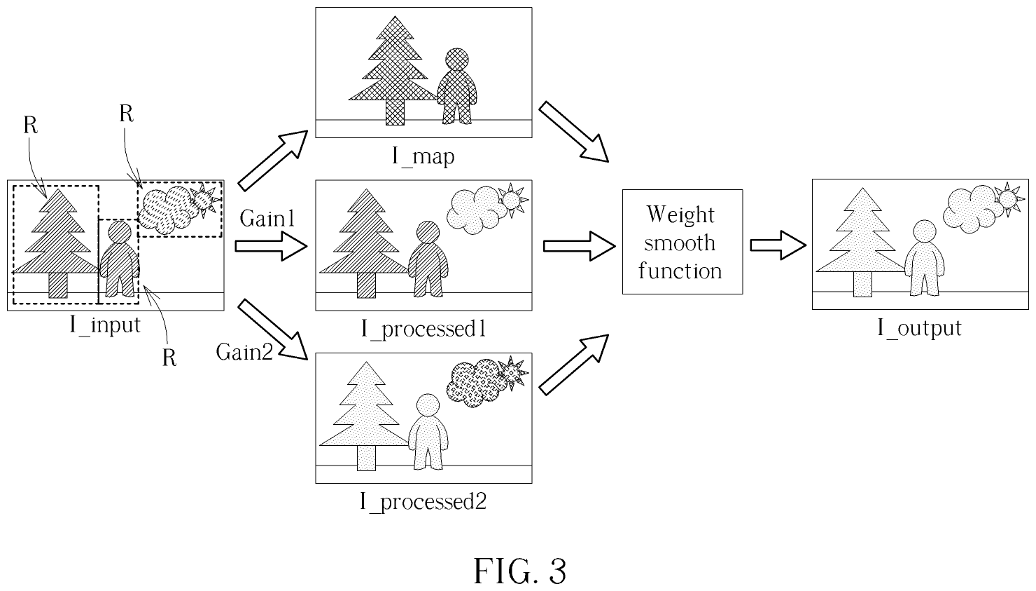

Please refer to FIG. 1 to FIG. 3. FIG. 1 is a functional block diagram of an image processing device 10 according to an embodiment of the present application. FIG. 2 is a flow chart of an image processing method according to the embodiment of the present application. FIG. 3 is a functional block diagram of conversion process of an input image I_input according to the embodiment of the present application. The image processing device 10 can include an image receiver 12 and an operation module 14 electrically connected to each other in a wire manner or in a wireless manner. The image receiver 12 can be an image capturing unit used to capture the input image I_input, or a signal transmitting unit used to receive the input image I_input captured by an external device. The operation module 14 can be software or an image signal processor, and the image signal processor can be a built-in processing unit of the camera, or a cloud or an external server. The operation module 14 can execute the image processing method, so as to adjust brightness of one or some specific regions within the input image I_input, and other regions within the input image I_input that have the adjusted brightness or original brightness are not affected by the foresaid specific regions.

For the image processing method, step S100 can be executed to set a plurality of regions of interest R within the input image I_input. The regions of interest R can be automatically set by image identification technology, or can be manually set by a control command provided by the user. The regions of interest R may contain a high intensity area and a low intensity area of the input image I_input, or further contain a foreground area and a background area of the input image I_input. Some specific content inside the input image I_input, such as the person, the vehicle, or any possible objects, can be marked by the regions of interest R for individual brightness adjustment. Then, step S102 and step S104 can be executed to generate a weight map I_map in accordance with the plurality of regions of interest R identified from the input image I_input, and further to apply a plurality of gain values to the input image I_input for respectively generating a plurality of duplicated images I_processed1 and I_processed2. A number of the duplicated images is not limited to the foresaid embodiment.

In step S102, the specific content, such as the tree, the person and the cloud, can be selected by the regions of interest R, and all the specific content can have corresponding weighting values to establish the weight map I_map. The weighting value of each of the specific content can be defined in accordance with property of the specific content and requirement of visual presentation; for example, the human face of the foreground may have the greater weighting value, and the cloud of the background may have the lower weighting value. The plurality of weighting values that respectively corresponds to the plurality of regions of interest R can be set in accordance with a number and distribution of the plurality of regions of interest R. According to the next step, the duplicated image I_processed1 can be generated by the input image I_input and the related gain value (such as Gain 1), and the duplicated image I_processed2 can be generated by the input image I_input and the related gain value (such as Gain 2), so that the duplicated image I_processed1 may have preferred effect on the tree and the person, and the duplicated image I_processed2 may have preferred effect on the cloud and the sun; therefore, the weight map I_map can be applied to select the preferred effect respectively from the duplicated image I_processed1 and the duplicated image I_processed2 for the synthesizing process.

In step S104, the gain values can be preset and stored by the image processing device 10, and used to adjust the brightness of contrast of the adjacent objects inside the input image I_input. For example, the input image I_input can be duplicated and separately sent to multiple flows, and all pixels of the input image I_input in one flow can be adjusted by one corresponding gain value to generate the duplicated image I_processed1, and all pixels of the input image I_input in another flow can be adjusted by another gain value to generate the duplicated image I_processed2.

In the embodiment of the present application, the human face is intend to be relighted and the cloud is not, so that the duplicated image I_processed2 can be processed by the gain value (such as gain 2 favor to the interested content) to relight the person and probably the tree into the appropriate brightness but may sacrifice the contrast in the highlight area, and the duplicated image I_processed1 can be processed by the gain value (such as gain 1 favor to the highlight background) to slightly adjust the highlight area and keep the contrast in the highlight area, such as the cloud or the sun of the background, which may lose some texture in the dark area. The duplicated image I_processed1 can be darker than the duplicated image I_processed2, and the duplicated images I_processed1 and I_processed2 can be fused or synthesized to keep its own advantages, so that the brightness of the specific content inside the input image I_input can be adequately controlled and inherited in the present application. Actual objects inside the specific content inside the input image I_input cannot be limited to the above-mentioned embodiment, and relation between the weighting value and the specific content and relation between the weighting value and the gain value may be changed due to the actual objects inside the input image I_input, and a detailed description is omitted herein for simplicity.

It should be mentioned that the weight map I_map is generated based on the input image I_input instead of the plurality of duplicated images I_processed1 and I_processed2, so that the input image I_input may be transformed into the weight map I_map and the duplicated images I_processed1 and I_processed2 simultaneously, or generation process of the weight map I_map can be parallel to duplication process of the duplicated images I_processed1 and I_processed2, so that the image processing method of the present application can benefit from less latency and more flexibility. Further, the generation process of the weight map I_map may be earlier than or later than the duplication process of the duplicated images I_processed1 and I_processed2, which depends on a design demand.

Then, step S106 can be executed to utilize a weight smooth function to calibrate difference in the plurality of weighting values of the weight map I_map respectively corresponding to the plurality of regions of interest R. In step S106, the weight map I_map may contain several regions of interest R that have different weighting values. The region of interest R which corresponds to the person can have the weighting value totally different from the weighting value of the region of interest R which corresponds to the cloud, and a boundary between the region of interest R corresponding to the person and the adjacent region of interest R corresponding to the cloud is obvious, so the weight smooth function may define another transition region that is located between the foresaid two regions of interest R (which respectively correspond to the person and the cloud) and further set another weighting value ranged between the weighting values of the foresaid two regions of interest R for the defined transition region; therefore; gradient change of the brightness between the foresaid two regions of interest R can be more natural via calibration of the weight smooth function.

Then, step S108 can be executed to synthesize the duplicated images I_processed1 and I_processed2 via the weighting values described on the weight map I_map for acquiring an output image I_output. In step S108, the output image I_output may be optionally processed to calibrate one or some pixels that has the pixel value not conforming to the predefined condition, and each of the duplicated images I_processed1 and I_processed2 can be processed for only one of the regions of interest R by the related weighting value of the weight map I_map for synthesis, and the weight smooth function can be applied to make synthesis result of the output image I_output more natural and without artifact.

In conclusion, the image processing method and the image processing device of the present application can perform flexible exposure control based on multi-ROI, so as to flexibly control the brightness of the specific content inside the input image with less influence by other content. The image processing method can duplicate the input image to multiple ones, and apply the multiply gains favor to each ROI to each the duplicated images; the image processing method can further generate the weight map, which includes the weight smooth function and is parallel to other image processing, and synthesize the duplicated images via the weight map to acquire the output image that is natural and artifact-less for preferred image quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method of increasing image quality, comprising:
setting a plurality of regions of interest within an input image;
generating a weight map in accordance with the plurality of regions of interest identified from the input image;
applying a plurality of gain values to the input image for respectively generating a plurality of duplicated images; and
utilizing the weight map to synthesize the plurality of duplicated images for acquiring an output image.

2. The image processing method of claim 1, further comprising:
setting a plurality of weighting values of the weight map respectively corresponding to the plurality of regions of interest in accordance with a number and distribution of the plurality of regions of interest.

3. The image processing method of claim 1, wherein the weight map is generated based on the input image instead of the plurality of duplicated images.

4. The image processing method of claim 1, further comprising:
utilizing a weight smooth function to calibrate difference in a plurality of weighting values of the weight map respectively corresponding to the plurality of regions of interest.

5. The image processing method of claim 1, further comprising:
applying one of the plurality of gain values to all pixels of the input image for generating one corresponding duplicated image.

6. An image processing device of increasing image quality, comprising:
an image receiver adapted to receive an input image; and
an operation module electrically connected with the image receiver, the operation module being adapted to identify and set a plurality of regions of interest within the input image, generate a weight map in accordance with the plurality of regions of interest from the input image, apply a plurality of gain values to the input image for respectively generating a plurality of duplicated images, and utilize the weight map to synthesize the plurality of duplicated images for acquiring an output image.

7. The image processing device of claim 6, wherein the plurality of regions of interest are a high intensity area and a low intensity area of the input image, or are a foreground area and a background area of the input image.

8. The image processing device of claim 6, wherein the operation module transforms the input image simultaneously into the weight map and the plurality of duplicated images respectively by the plurality of regions of interest and the plurality of gain values.

9. The image processing device of claim 6, wherein the operation module sets a plurality of weighting values of the weight map respectively corresponding to the plurality of regions of interest in accordance with a number and distribution of the plurality of regions of interest.

10. The image processing device of claim 6, wherein the weight map is generated based on the input image instead of the plurality of duplicated images.

11. The image processing device of claim 6, wherein the operation module utilizes a weight smooth function to calibrate difference in a plurality of weighting values of the weight map respectively corresponding to the plurality of regions of interest.

12. The image processing device of claim 6, wherein the operation module applies one of the plurality of gain values to all pixels of the input image for generating one corresponding duplicated image.
